(19) United States
(12) Patent Application Publication
(10) Pub. No.: US 2025/0142411 A1
(43) Pub. Date: May 1, 2025

(54) SYSTEMS AND METHODS FOR FRONTHAUL TRAFFIC SHAPING

(71) Applicant: Rakuten Symphony, Inc., Tokyo (JP)

(72) Inventors: Siddhant GUPTA, Bangalore (IN); Ronak Bharatkumar LALWALA, Bangalore (IN)

(21) Appl. No.: 18/495,766

(22) Filed: Oct. 27, 2023

(51) Int. Cl. H04W 28/088

(52) U.S. Cl. CPC H04W 28/088

(57) ABSTRACT

A network testing system includes a non-transitory computer readable medium configured to store instructions thereon; and a processor. The processor is configured to execute the instructions for identifying a first set of fronthaul ports comprising a first fronthaul port; identifying a second set of fronthaul ports comprising a second fronthaul port; determining whether the first fronthaul port is active; determining whether the second fronthaul port is active; assigning a first portion of fronthaul traffic to the first set of fronthaul ports based on a first set of determinations, wherein the first set of determinations comprise a first port activity determination that the first fronthaul port is active; and assigning a second portion of the fronthaul traffic to the second set of fronthaul ports based on a second set of determinations.

### TECHNICAL FIELD

This description relates to an O-RAN fronthaul (FH) traffic shaping system and a method of using an O-RAN fronthaul (FH) traffic shaping system.

### BACKGROUND

Open Radio Access Network (O-RAN) is a technology that aims to create more open and interoperable cellular networks. O-RAN is an evolution of Radio Access Network (RAN) architecture. In some instances, O-RAN is controlled by a single operator.

The O-RAN architecture uses a distributed system of intelligent software agents, known as “white boxes,” to control the network. This allows for greater scalability and the ability to use a variety of different hardware components from different vendors.

O-RAN provides the ability to easily add new features and capabilities to the network by use of software-defined networking (SDN) and network functions virtualization (NFV) technologies.

O-RAN also helps to reduce costs for operators by allowing for the use of cheaper and more efficient hardware components. This helps to lower costs, which are potentially a barrier to the deployment of cellular networks.

Some elements of the O-RAN architecture include the Service Management and Orchestration Framework (SMO), RAN Intelligent Controller (RIC), O-Cloud, O-RAN central unit (O-CU or OCU), O-RAN distributed unit (O-DU or ODU), and O-RAN Radio unit (O-RU or ORU).

A control plane (C-plane) is responsible for signaling and control operations in the network by communicating with other network elements to coordinate and control various functions, such as call setup, mobility management and network resource allocation.

A user plane (U-plane) is responsible for delivering data and voice services to the end-users by transporting the actual user traffic between the radio access network and the core network.

A management plane (M-plane) provides centralized management and monitoring of the network elements, as well as configuration and maintenance of the network. The M-plane is responsible for monitoring the health and performance of the network, collecting statistics, and managing software upgrades and other network changes.

O-RAN provides a more secure network by separating the control plane and the data plane. This allows for greater flexibility in the deployment of security measures, such as firewalls, intrusion detection systems, and encryption.

### SUMMARY

A system includes a non-transitory computer readable medium configured to store instructions thereon. The system further includes a processor connected to the non-transitory computer readable medium. The processor is configured to execute the instructions for identifying a first set of fronthaul ports comprising a first fronthaul port. The processor is configured to execute the instructions for identifying a second set of fronthaul ports comprising a second fronthaul port. The processor is configured to execute the instructions for determining whether the first fronthaul port is active. The processor is configured to execute the instructions for determining whether the second fronthaul port is active. The processor is configured to execute the instructions for assigning a first portion of fronthaul traffic to the first set of fronthaul ports based on a first set of determinations, wherein the first set of determinations comprise a first port activity determination that the first fronthaul port is active. The processor is configured to execute the instructions for assigning a second portion of the fronthaul traffic to the second set of fronthaul ports based on a second set of determinations.

A method includes identifying a first set of fronthaul ports comprising a first fronthaul port. The method further includes identifying a second set of fronthaul ports comprising a second fronthaul port. The method further includes determining whether the first fronthaul port is active. The method further includes determining whether the second fronthaul port is active. The method further includes assigning a first portion of fronthaul traffic to the first set of fronthaul ports based on a first set of determinations, wherein the first set of determinations comprise a first port activity determination that the first fronthaul port is active. The method further includes assigning a second portion of the fronthaul traffic to the second set of fronthaul ports based on a second set of determinations.

A non-transitory computer readable medium configured to store instructions thereon. The instructions are configured to cause a processor to perform operations comprising identifying a first set of fronthaul ports comprising a first fronthaul port. The instructions are configured to cause a processor to perform operations comprising identifying a second set of fronthaul ports comprising a second fronthaul port. The instructions are configured to cause a processor to perform operations comprising determining whether the first fronthaul port is active. The instructions are configured to cause a processor to perform operations comprising determining whether the second fronthaul port is active. The instructions are configured to cause a processor to perform operations comprising assigning a first portion of fronthaul traffic to the first set of fronthaul ports based on a first set of determinations, wherein the first set of determinations comprise a first port activity determination that the first fronthaul port is active. The instructions are configured to cause a processor to perform operations comprising assigning a second portion of the fronthaul traffic to the second set of fronthaul ports based on a second set of determinations.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of an O-RAN system, according to at least some embodiments of the subject disclosure.

FIG. 2 is a schematic diagram of an O-RAN fronthaul (FH) traffic shaping system, in accordance with some embodiments.

FIG. 3 is a schematic diagram of an O-RAN fronthaul (FH) traffic shaping system, in accordance with some embodiments.

FIG. 4 is a schematic diagram of an O-RAN fronthaul (FH) traffic shaping system, in accordance with some embodiments.

FIG. 5 is a schematic diagram of an O-RAN fronthaul (FH) traffic shaping system, in accordance with some embodiments.

FIG. 6 is a schematic diagram of an O-RAN fronthaul (FH) traffic shaping system, in accordance with some embodiments.

FIG. 7 is a schematic diagram of an O-RAN fronthaul (FH) traffic shaping system, in accordance with some embodiments.

FIG. 8 is a sequence diagram of a method of using an O-RAN fronthaul (FH) traffic shaping system, in accordance with some embodiments.

FIG. 9 is a block diagram of computer architecture in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

There are several instances wherein technology evolution creates inconsistencies or incompatibilities between previous capabilities and newly introduced capabilities. In some instances, technologies become stale, outdated or become unable to provide support for newly introduced capabilities. In some instances, technologies are built with specific parameters or limitations that are unable to accommodate growth or unanticipated introduction of technology features.

In some instances, telecommunications, wireless, or cellular technology becomes outdated due to the rapid evolution or use of technology in the wireless or cellular technology area. As a result, rapid adaptability and new solutions are needed to accommodate rapidly changing broadband cellular network technology.

In some instances, a shift in technological capabilities or features is observable between fourth generation (4G)/Long-Term Evolution (LTETM) and fifth generation (5G) broadband cellular network technology. LTETM sought to increase the capacity and speed of wireless data networks using new DSP (digital signal processing) techniques and modulations that previously were developed, and to redesign and simplify the network architecture to an internet protocol (IP) based system with reduced transfer latency, compared with the third generation (3G) broadband cellular network technology. Yet not only are 5G networks even faster than predecessor 4G networks, 5G possesses higher bandwidth and is able to connect a larger number of different devices, improving quality of internet services.

In some instances, technological capabilities have not yet advanced to meet more nuanced and developing needs. That is, increasing technological complexity creates a need for more granular and nuanced solutions and compatibility.

In some more specific instances, O-RAN Fronthaul (FH) traffic handling systems and method have not yet evolved to meet increasing Fronthaul traffic complexity needs. FH ports are not used optimally and FH traffic is not allocated to FH ports optimally. That is, a technological mismatch or deficiency in accommodating new technology needs has occurred.

In order to help reduce or solve these problems associated with technological evolution or shifts described, the current description includes systems and methods that accommodate evolving FH traffic management and FH port allocation needs. The current description includes systems and methods that allow for more appropriate or more efficient load balancing.

The current description includes systems and methods to more efficiently distribute traffic to service resources. As a result, the current description includes systems and methods that are able to address deficiencies associated with technological mismatches or outdated architecture.

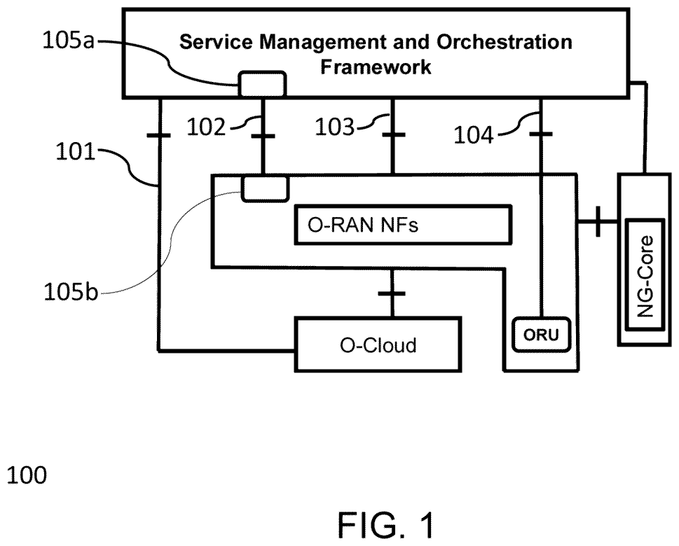

FIG. 1 is a schematic diagram of an O-RAN system 100, according to at least some embodiments of the subject disclosure.

O-RAN system 100 includes four interfaces A1 (102), O1 (103), Open Fronthaul M-plane interface (104) and O2 (101) that connect SMO (Service Management and Orchestration) 105 framework to O-RAN network functions and O-Cloud 106, a cloud computing platform comprising a collection of physical infrastructure nodes meeting O-RAN requirements to host relevant O-RAN functions. In some cases, O-RAN Network Functions 107 are VNFs (Virtualized Network Function) and/or PNFs (Physical Network Function) utilizing customized hardware Non-Real-Time RAN Intelligent Controller (Non-RT RIC) is shown at 107a, and Near-Real-Time RAN Intelligent Controller (Near-RT RIC) is shown at 107b. Near-RT RIC 107a is a logical function that enables near-real-time control and optimization of RAN elements and resources via fine-grained data collection and actions. Non-RT RIC 107b is a logical function within SMO 105 that drives the content carried across the AI interface 102. Open Fronthaul M-plane interface (104) interfaces SMO 105 and O-RU 108. Mobile Core 109 is a bundle of functionality for authenticating devices, providing Internet (IP) connectivity, tracking user mobility, tracking subscriber usage, etc.

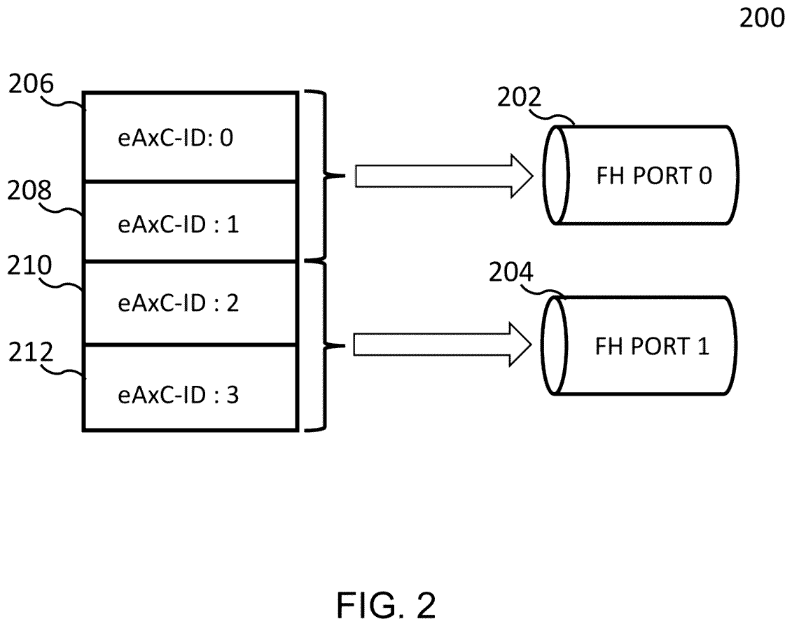

FIG. 2 is a schematic diagram of an O-RAN fronthaul (FH) traffic shaping system 200, in accordance with some embodiments.

The O-RAN fronthaul traffic shaping system 200 includes a first fronthaul port 202 (“FH Port 0”). The first fronthaul port 202 is configured to receive O-RAN fronthaul traffic. In some embodiments, the first fronthaul port 202 is configured to receive, manage, transmit, or deliver any type of traffic. In some embodiments, the first fronthaul port 202 is configured to receive, manage, transmit, or deliver fronthaul traffic. In some embodiments, the first fronthaul port 202 is configured to receive, manage, transmit, or deliver fronthaul C-Plane traffic. In some embodiments, the first fronthaul port 202 is configured to receive, manage, transmit, or deliver fronthaul U-Plane traffic. In some embodiments, the first fronthaul port 202 is configured to receive, manage, transmit, or deliver fronthaul C-Plane and U-Plane traffic. In some embodiments, the first fronthaul port 202 is configured to receive, manage, transmit, or deliver uplink data or traffic. In some embodiments, the first fronthaul port 202 is configured to receive, manage, transmit, or deliver downlink data or traffic.

The O-RAN fronthaul traffic shaping system 200 includes a second fronthaul port 204 (“FH Port 1”). The second fronthaul port 204 is configured to receive O-RAN fronthaul traffic. In some embodiments, the second fronthaul port 204 is configured to receive, manage, transmit, or deliver any type of traffic. In some embodiments, the second fronthaul port 204 is configured to receive, manage, transmit, or deliver fronthaul traffic. In some embodiments, the second fronthaul port 204 is configured to receive, manage, transmit, or deliver fronthaul C-Plane traffic. In some embodiments, the second fronthaul port 204 is configured to receive, manage, transmit, or deliver fronthaul U-Plane traffic. In some embodiments, the second fronthaul port 204 is configured to receive, manage, transmit, or deliver fronthaul C-Plane and U-Plane traffic. In some embodiments, the second fronthaul port 204 is configured to receive, manage, transmit, or deliver uplink data or traffic. In some embodiments, the second fronthaul port 204 is configured to receive, manage, transmit, or deliver downlink data or traffic.

The O-RAN fronthaul traffic shaping system 200 is configured to assign or map fronthaul traffic based on eAxC-ID. A first portion of fronthaul traffic associated with eAxC-ID 0 (206), eAxC-ID 1 (208), eAxC-ID 2 (210), and eAxC-ID 3 (212) is identified, determined, received, and transmitted. A second portion of fronthaul traffic associated with eAxC-ID 0 (206), eAxC-ID 1 (208) is mapped and assigned to and using fronthaul port 202. Fronthaul traffic associated with eAxC-ID 2 (210), eAxC-ID 3 (212) is mapped and assigned to and using fronthaul port 204.

One of ordinary skill in the art would understand that a similar mapping and assigning for any number of eAxC-IDs is within the scope of this description. One of ordinary skill in the art would understand that a similar mapping and assigning for any type or number of ports is within the scope of this description. One of ordinary skill in the art would understand that a similar mapping and assigning for any configuration or combination of eAxC-IDs and ports is within the scope of this description.

In some embodiments, a determination is made whether one or more fronthaul ports are active or in a standby mode. In some embodiments, Loopback Messages (LBM) and Loopback Replies (LBR) are used to determine whether a fronthaul port is active. In some embodiments, a heartbeat message is used to determine whether a fronthaul port is active.

In some embodiments, a first portion of fronthaul traffic is mapped or assigned to a first portion of available or active fronthaul ports. In some embodiments, a first portion of fronthaul traffic comprises C-Plane traffic. In some embodiments, a first portion of fronthaul traffic comprises U-Plane traffic. In some embodiments, a first portion of fronthaul traffic comprises C-Plane and U-Plane traffic. In some embodiments, a first portion of available or active fronthaul ports comprises a first range of available or active fronthaul ports. In some embodiments, a first portion of available or active fronthaul ports comprises half or approximately half of available or active fronthaul ports. For example, in some embodiments, a first portion of available or active fronthaul ports maps to all ports with even number identifiers. In another example, in some embodiments, a first portion of available or active fronthaul ports maps to all ports with odd number identifiers. In another example, in some embodiments, a first portion of available or active fronthaul ports to every other port. In some embodiments, a first portion of available or active fronthaul ports is mapped or assigned to fronthaul traffic that meet the following criteria: for fronthaul traffic identified or associated with a total number N of eAxC-IDs, fronthaul traffic that is identified or associated with eAxC-IDs that fall within a range of 1 to N/2−1.

In some embodiments, a second portion of fronthaul traffic is mapped or assigned to a second portion of available or active fronthaul ports. In some embodiments, a second portion of fronthaul traffic comprises C-Plane traffic. In some embodiments, a second portion of fronthaul traffic comprises U-Plane traffic. In some embodiments, a second portion of fronthaul traffic comprises C-Plane and U-Plane traffic. In some embodiments, a second portion of available or active fronthaul ports comprises a second range of available or active fronthaul ports. In some embodiments, a second portion of available or active fronthaul ports comprises half or approximately half of available or active fronthaul ports. In some embodiments, a second portion of available or active fronthaul ports comprises half or approximately half of available or active fronthaul ports that does not include a first portion of available or active fronthaul ports. For example, in some embodiments, a second portion of available or active fronthaul ports maps to all ports with even number identifiers. In another example, in some embodiments, a second portion of available or active fronthaul ports maps to all ports with odd number identifiers. In another example, in some embodiments, a second portion of available or active fronthaul ports to every other port. In some embodiments, a second portion of available or active fronthaul ports is mapped or assigned to fronthaul traffic that meet the following criteria: for fronthaul traffic identified or associated with a total number N of eAxC-IDs, fronthaul traffic that is identified or associated with eAxC-IDs that fall within a range of N/2 to N−1.

Utilizing the O-RAN fronthaul traffic shaping system 200 helps load balance traffic because traffic is more systematically or evenly distributed among available resources. As a result, for example, service impact of dropped packets, is lessened.

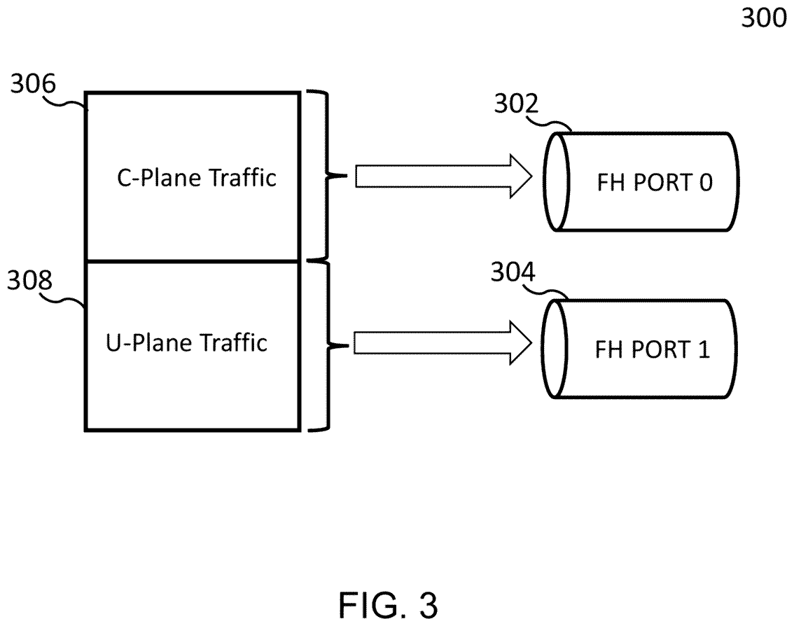

FIG. 3 is a schematic diagram of an O-RAN fronthaul (FH) traffic shaping system 300, in accordance with some embodiments.

The O-RAN fronthaul traffic shaping system 300 includes a first fronthaul port 302 (“FH Port 0”). The first fronthaul port 302 is configured to receive O-RAN fronthaul traffic. In some embodiments, the first fronthaul port 302 is configured to receive, manage, transmit, or deliver any type of traffic. In some embodiments, the first fronthaul port 302 is configured to receive, manage, transmit, or deliver fronthaul traffic. In some embodiments, the first fronthaul port 302 is configured to receive, manage, transmit, or deliver fronthaul C-Plane traffic. In some embodiments, the first fronthaul port 302 is configured to receive, manage, transmit, or deliver fronthaul U-Plane traffic. In some embodiments, the first fronthaul port 302 is configured to receive, manage, transmit, or deliver fronthaul C-Plane and U-Plane traffic. In some embodiments, the first fronthaul port 302 is configured to receive, manage, transmit, or deliver uplink data or traffic. In some embodiments, the first fronthaul port 302 is configured to receive, manage, transmit, or deliver downlink data or traffic.

The O-RAN fronthaul traffic shaping system 300 includes a second fronthaul port 304 (“FH Port 1”). The second fronthaul port 304 is configured to receive O-RAN fronthaul traffic. In some embodiments, the second fronthaul port 304 is configured to receive, manage, transmit, or deliver any type of traffic. In some embodiments, the second fronthaul port 304 is configured to receive, manage, transmit, or deliver fronthaul traffic. In some embodiments, the second fronthaul port 304 is configured to receive, manage, transmit, or deliver fronthaul C-Plane traffic. In some embodiments, the second fronthaul port 304 is configured to receive, manage, transmit, or deliver fronthaul U-Plane traffic. In some embodiments, the second fronthaul port 304 is configured to receive, manage, transmit, or deliver fronthaul C-Plane and U-Plane traffic. In some embodiments, the second fronthaul port 304 is configured to receive, manage, transmit, or deliver uplink data or traffic. In some embodiments, the second fronthaul port 304 is configured to receive, manage, transmit, or deliver downlink data or traffic.

The O-RAN fronthaul traffic shaping system 300 is configured to assign or map fronthaul traffic based on traffic type. Fronthaul traffic associated with C-Plane traffic and U-Plane traffic is identified, determined, received, and transmitted. A first portion of fronthaul traffic associated with C-Plane traffic 306 is mapped and assigned to and using fronthaul port 302. A second portion of fronthaul traffic associated with U-Plane traffic 308 is mapped and assigned to and using fronthaul port 304.

One of ordinary skill in the art would understand that a similar mapping and assigning based on any type of traffic is within the scope of this description. One of ordinary skill in the art would understand that a similar mapping and assigning for any type or number of ports is within the scope of this description. One of ordinary skill in the art would understand that a similar mapping and assigning for any configuration or combination any type of traffic and ports is within the scope of this description.

In some embodiments, a first portion of fronthaul traffic is mapped or assigned to a first portion of available or active fronthaul ports. In some embodiments, a first portion of fronthaul traffic comprises C-Plane traffic. In some embodiments, a first portion of fronthaul traffic comprises U-Plane traffic. In some embodiments, a first portion of fronthaul traffic comprises C-Plane and U-Plane traffic. In some embodiments, a first portion of available or active fronthaul ports comprises a first range of available or active fronthaul ports. In some embodiments, a first portion of available or active fronthaul ports comprises half or approximately half of available or active fronthaul ports. For example, in some embodiments, a first portion of available or active fronthaul ports maps to all ports with even number identifiers. In another example, in some embodiments, a first portion of available or active fronthaul ports maps to all ports with odd number identifiers. In another example, in some embodiments, a first portion of available or active fronthaul ports to every other port.

In some embodiments, a second portion of fronthaul traffic is mapped or assigned to a second portion of available or active fronthaul ports. In some embodiments, a second portion of fronthaul traffic comprises C-Plane traffic. In some embodiments, a second portion of fronthaul traffic comprises U-Plane traffic. In some embodiments, a second portion of fronthaul traffic comprises C-Plane and U-Plane traffic. In some embodiments, a second portion of available or active fronthaul ports comprises a second range of available or active fronthaul ports. In some embodiments, a second portion of available or active fronthaul ports comprises half or approximately half of available or active fronthaul ports. In some embodiments, a second portion of available or active fronthaul ports comprises half or approximately half of available or active fronthaul ports that does not include a first portion of available or active fronthaul ports. For example, in some embodiments, a second portion of available or active fronthaul ports maps to all ports with even number identifiers. In another example, in some embodiments, a second portion of available or active fronthaul ports maps to all ports with odd number identifiers. In another example, in some embodiments, a second portion of available or active fronthaul ports to every other port.

Utilizing the O-RAN fronthaul traffic shaping system 300 helps load balance traffic because traffic is more systematically or evenly distributed among available resources. As a result, for example, service impact of dropped packets, is lessened.

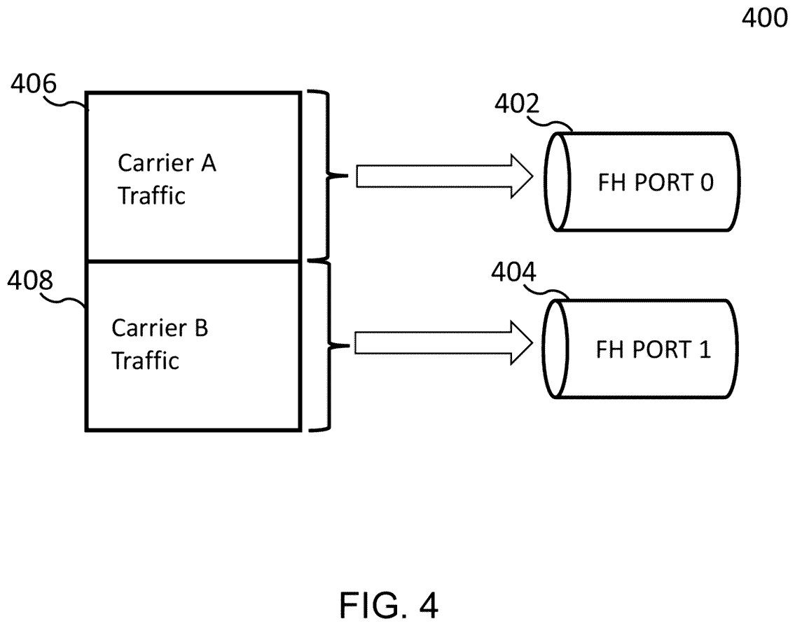

FIG. 4 is a schematic diagram of an O-RAN fronthaul (FH) traffic shaping system 400, in accordance with some embodiments.

The O-RAN fronthaul traffic shaping system 400 includes a first fronthaul port 402 (“FH Port 0”). The first fronthaul port 402 is configured to receive O-RAN fronthaul traffic. In some embodiments, the first fronthaul port 402 is configured to receive, manage, transmit, or deliver any type of traffic. In some embodiments, the first fronthaul port 402 is configured to receive, manage, transmit, or deliver fronthaul traffic. In some embodiments, the first fronthaul port 402 is configured to receive, manage, transmit, or deliver fronthaul C-Plane traffic. In some embodiments, the first fronthaul port 402 is configured to receive, manage, transmit, or deliver fronthaul U-Plane traffic. In some embodiments, the first fronthaul port 402 is configured to receive, manage, transmit, or deliver fronthaul C-Plane and U-Plane traffic. In some embodiments, the first fronthaul port 402 is configured to receive, manage, transmit, or deliver uplink data or traffic. In some embodiments, the first fronthaul port 402 is configured to receive, manage, transmit, or deliver downlink data or traffic.

The O-RAN fronthaul traffic shaping system 400 includes a second fronthaul port 404 (“FH Port 1”). The second fronthaul port 404 is configured to receive O-RAN fronthaul traffic. In some embodiments, the second fronthaul port 404 is configured to receive, manage, transmit, or deliver any type of traffic. In some embodiments, the second fronthaul port 404 is configured to receive, manage, transmit, or deliver fronthaul traffic. In some embodiments, the second fronthaul port 404 is configured to receive, manage, transmit, or deliver fronthaul C-Plane traffic. In some embodiments, the second fronthaul port 404 is configured to receive, manage, transmit, or deliver fronthaul U-Plane traffic. In some embodiments, the second fronthaul port 404 is configured to receive, manage, transmit, or deliver fronthaul C-Plane and U-Plane traffic. In some embodiments, the second fronthaul port 404 is configured to receive, manage, transmit, or deliver uplink data or traffic. In some embodiments, the second fronthaul port 404 is configured to receive, manage, transmit, or deliver downlink data or traffic.

The O-RAN fronthaul traffic shaping system 400 is configured to assign or map fronthaul traffic based on carrier. Fronthaul traffic associated with each carrier is identified, determined, received, and transmitted. A first portion of fronthaul traffic associated with Carrier A 406 is mapped and assigned to and using fronthaul port 402. A second portion of fronthaul traffic associated with Carrier B 308 is mapped and assigned to and using fronthaul port 404.

One of ordinary skill in the art would understand that a similar mapping and assigning based on any type or number of carriers is within the scope of this description. One of ordinary skill in the art would understand that a similar mapping and assigning for any type or number of ports is within the scope of this description. One of ordinary skill in the art would understand that a similar mapping and assigning for any configuration or combination any type or number of carriers and ports is within the scope of this description.

In some embodiments, a first portion of fronthaul traffic is mapped or assigned to a first portion of available or active fronthaul ports. In some embodiments, a first portion of fronthaul traffic comprises C-Plane traffic. In some embodiments, a first portion of fronthaul traffic comprises U-Plane traffic. In some embodiments, a first portion of fronthaul traffic comprises C-Plane and U-Plane traffic. In some embodiments, a first portion of available or active fronthaul ports comprises a first range of available or active fronthaul ports. In some embodiments, a first portion of available or active fronthaul ports comprises half or approximately half of available or active fronthaul ports. For example, in some embodiments, a first portion of available or active fronthaul ports maps to all ports with even number identifiers. In another example, in some embodiments, a first portion of available or active fronthaul ports maps to all ports with odd number identifiers. In another example, in some embodiments, a first portion of available or active fronthaul ports to every other port.

In some embodiments, a second portion of fronthaul traffic is mapped or assigned to a second portion of available or active fronthaul ports. In some embodiments, a second portion of fronthaul traffic comprises C-Plane traffic. In some embodiments, a second portion of fronthaul traffic comprises U-Plane traffic. In some embodiments, a second portion of fronthaul traffic comprises C-Plane and U-Plane traffic. In some embodiments, a second portion of available or active fronthaul ports comprises a second range of available or active fronthaul ports. In some embodiments, a second portion of available or active fronthaul ports comprises half or approximately half of available or active fronthaul ports. In some embodiments, a second portion of available or active fronthaul ports comprises half or approximately half of available or active fronthaul ports that does not include a first portion of available or active fronthaul ports. For example, in some embodiments, a second portion of available or active fronthaul ports maps to all ports with even number identifiers. In another example, in some embodiments, a second portion of available or active fronthaul ports maps to all ports with odd number identifiers. In another example, in some embodiments, a second portion of available or active fronthaul ports to every other port.

Utilizing the O-RAN fronthaul traffic shaping system 400 helps load balance traffic because traffic is more systematically or evenly distributed among available resources. As a result, for example, service impact of dropped packets, is lessened.

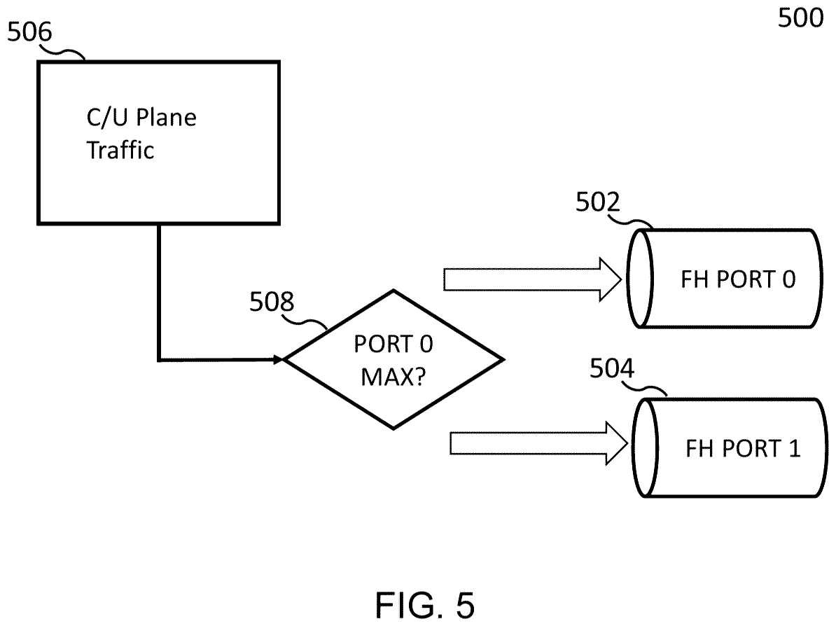

FIG. 5 is a schematic diagram of an O-RAN fronthaul (FH) traffic shaping system 500, in accordance with some embodiments.

The O-RAN fronthaul traffic shaping system 500 includes a first fronthaul port 502 (“FH Port 0”). The first fronthaul port 502 is configured to receive O-RAN fronthaul traffic. In some embodiments, the first fronthaul port 502 is configured to receive, manage, transmit, or deliver any type of traffic. In some embodiments, the first fronthaul port 502 is configured to receive, manage, transmit, or deliver fronthaul traffic. In some embodiments, the first fronthaul port 502 is configured to receive, manage, transmit, or deliver fronthaul C-Plane traffic. In some embodiments, the first fronthaul port 502 is configured to receive, manage, transmit, or deliver fronthaul U-Plane traffic. In some embodiments, the first fronthaul port 502 is configured to receive, manage, transmit, or deliver fronthaul C-Plane and U-Plane traffic. In some embodiments, the first fronthaul port 502 is configured to receive, manage, transmit, or deliver uplink data or traffic. In some embodiments, the first fronthaul port 502 is configured to receive, manage, transmit, or deliver downlink data or traffic.

The O-RAN fronthaul traffic shaping system 500 includes a second fronthaul port 504 (“FH Port 1”). The second fronthaul port 504 is configured to receive O-RAN fronthaul traffic. In some embodiments, the second fronthaul port 504 is configured to receive, manage, transmit, or deliver any type of traffic. In some embodiments, the second fronthaul port 504 is configured to receive, manage, transmit, or deliver fronthaul traffic. In some embodiments, the second fronthaul port 504 is configured to receive, manage, transmit, or deliver fronthaul C-Plane traffic. In some embodiments, the second fronthaul port 504 is configured to receive, manage, transmit, or deliver fronthaul U-Plane traffic. In some embodiments, the second fronthaul port 504 is configured to receive, manage, transmit, or deliver fronthaul C-Plane and U-Plane traffic. In some embodiments, the second fronthaul port 504 is configured to receive, manage, transmit, or deliver uplink data or traffic. In some embodiments, the second fronthaul port 504 is configured to receive, manage, transmit, or deliver downlink data or traffic.

The O-RAN fronthaul traffic shaping system 500 is configured to assign or map fronthaul traffic based on load determination or exhaustion. Fronthaul traffic is identified, determined, received, and transmitted. In operation 508, if it is determined that fronthaul port 502 is not exhausted, a first portion of fronthaul traffic 506 comprising C-Plane traffic and U-Plane traffic is mapped and assigned to and using fronthaul port 502. In operation 508, if it is determined that fronthaul port 502 is exhausted, a second portion fronthaul traffic 506 comprising C-Plane traffic and U-Plane traffic is mapped and assigned to and using fronthaul port 504.

One of ordinary skill in the art would understand that a similar mapping and assigning based on exhaustion or load of any port is within the scope of this description. One of ordinary skill in the art would understand that a similar mapping and assigning for any type or number of ports is within the scope of this description. One of ordinary skill in the art would understand that a similar mapping and assigning for any configuration or combination any port load or exhaustion and number of ports is within the scope of this description.

In some embodiments, a first portion of fronthaul traffic is mapped or assigned to a first portion of available or active fronthaul ports. In some embodiments, a first portion of fronthaul traffic comprises C-Plane traffic. In some embodiments, a first portion of fronthaul traffic comprises U-Plane traffic. In some embodiments, a first portion of fronthaul traffic comprises C-Plane and U-Plane traffic. In some embodiments, a first portion of available or active fronthaul ports comprises a first range of available or active fronthaul ports. In some embodiments, a first portion of available or active fronthaul ports comprises half or approximately half of available or active fronthaul ports. For example, in some embodiments, a first portion of available or active fronthaul ports maps to all ports with even number identifiers. In another example, in some embodiments, a first portion of available or active fronthaul ports maps to all ports with odd number identifiers. In another example, in some embodiments, a first portion of available or active fronthaul ports to every other port.

In some embodiments, a second portion of fronthaul traffic is mapped or assigned to a second portion of available or active fronthaul ports. In some embodiments, a second portion of fronthaul traffic comprises C-Plane traffic. In some embodiments, a second portion of fronthaul traffic comprises U-Plane traffic. In some embodiments, a second portion of fronthaul traffic comprises C-Plane and U-Plane traffic. In some embodiments, a second portion of available or active fronthaul ports comprises a second range of available or active fronthaul ports. In some embodiments, a second portion of available or active fronthaul ports comprises half or approximately half of available or active fronthaul ports. In some embodiments, a second portion of available or active fronthaul ports comprises half or approximately half of available or active fronthaul ports that does not include a first portion of available or active fronthaul ports. For example, in some embodiments, a second portion of available or active fronthaul ports maps to all ports with even number identifiers. In another example, in some embodiments, a second portion of available or active fronthaul ports maps to all ports with odd number identifiers. In another example, in some embodiments, a second portion of available or active fronthaul ports to every other port.

Utilizing the O-RAN fronthaul traffic shaping system 500 helps load balance traffic because traffic is more systematically or evenly distributed among available resources. As a result, for example, service impact of dropped packets, is lessened.

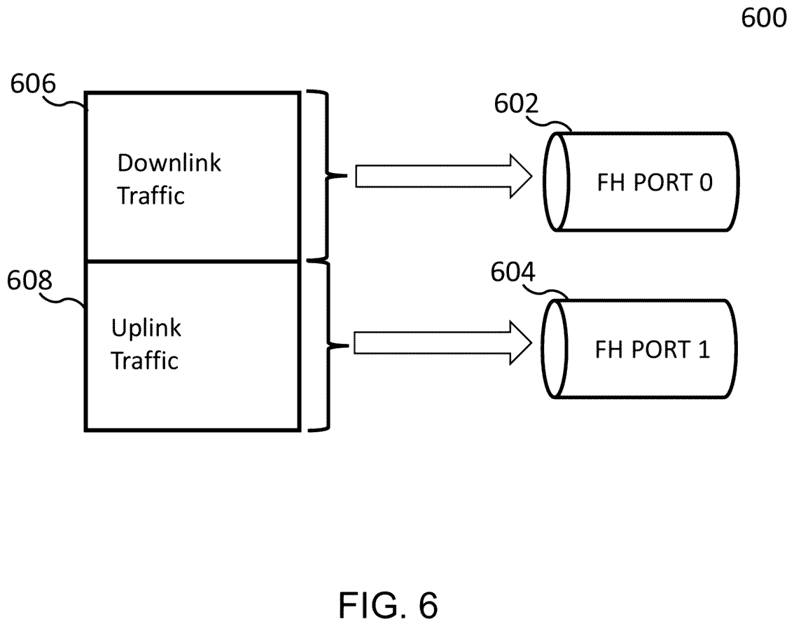

FIG. 6 is a schematic diagram of an O-RAN fronthaul (FH) traffic shaping system 600, in accordance with some embodiments.

The O-RAN fronthaul traffic shaping system 600 includes a first fronthaul port 602 (“FH Port 0”). The first fronthaul port 602 is configured to receive O-RAN fronthaul traffic. In some embodiments, the first fronthaul port 602 is configured to receive, manage, transmit, or deliver any type of traffic. In some embodiments, the first fronthaul port 602 is configured to receive, manage, transmit, or deliver fronthaul traffic. In some embodiments, the first fronthaul port 602 is configured to receive, manage, transmit, or deliver fronthaul C-Plane traffic. In some embodiments, the first fronthaul port 602 is configured to receive, manage, transmit, or deliver fronthaul U-Plane traffic. In some embodiments, the first fronthaul port 602 is configured to receive, manage, transmit, or deliver fronthaul C-Plane and U-Plane traffic. In some embodiments, the first fronthaul port 602 is configured to receive, manage, transmit, or deliver uplink data or traffic. In some embodiments, the first fronthaul port 602 is configured to receive, manage, transmit, or deliver downlink data or traffic.

The O-RAN fronthaul traffic shaping system 600 includes a second fronthaul port 604 (“FH Port 1”). The second fronthaul port 604 is configured to receive O-RAN fronthaul traffic. In some embodiments, the second fronthaul port 604 is configured to receive, manage, transmit, or deliver any type of traffic. In some embodiments, the second fronthaul port 604 is configured to receive, manage, transmit, or deliver fronthaul traffic. In some embodiments, the second fronthaul port 604 is configured to receive, manage, transmit, or deliver fronthaul C-Plane traffic. In some embodiments, the second fronthaul port 604 is configured to receive, manage, transmit, or deliver fronthaul U-Plane traffic. In some embodiments, the second fronthaul port 604 is configured to receive, manage, transmit, or deliver fronthaul C-Plane and U-Plane traffic. In some embodiments, the second fronthaul port 604 is configured to receive, manage, transmit, or deliver uplink data or traffic. In some embodiments, the second fronthaul port 604 is configured to receive, manage, transmit, or deliver downlink data or traffic.

The O-RAN fronthaul traffic shaping system 600 is configured to assign or map fronthaul traffic based on traffic type. Fronthaul traffic associated with each of uplink traffic and downlink traffic is identified, determined, received, and transmitted. A first portion of fronthaul traffic associated with downlink traffic 606 is mapped and assigned to and using fronthaul port 602. A second portion of fronthaul traffic associated with uplink traffic 608 is mapped and assigned to and using fronthaul port 604.

One of ordinary skill in the art would understand that a similar mapping and assigning based on any type of traffic is within the scope of this description. One of ordinary skill in the art would understand that a similar mapping and assigning for any type or number of ports is within the scope of this description. One of ordinary skill in the art would understand that a similar mapping and assigning for any configuration or combination any type of traffic and ports is within the scope of this description.

In some embodiments, a first portion of fronthaul traffic is mapped or assigned to a first portion of available or active fronthaul ports. In some embodiments, a first portion of fronthaul traffic comprises C-Plane traffic. In some embodiments, a first portion of fronthaul traffic comprises U-Plane traffic. In some embodiments, a first portion of fronthaul traffic comprises C-Plane and U-Plane traffic. In some embodiments, a first portion of available or active fronthaul ports comprises a first range of available or active fronthaul ports. In some embodiments, a first portion of available or active fronthaul ports comprises half or approximately half of available or active fronthaul ports. For example, in some embodiments, a first portion of available or active fronthaul ports maps to all ports with even number identifiers. In another example, in some embodiments, a first portion of available or active fronthaul ports maps to all ports with odd number identifiers. In another example, in some embodiments, a first portion of available or active fronthaul ports to every other port.

In some embodiments, a second portion of fronthaul traffic is mapped or assigned to a second portion of available or active fronthaul ports. In some embodiments, a second portion of fronthaul traffic comprises C-Plane traffic. In some embodiments, a second portion of fronthaul traffic comprises U-Plane traffic. In some embodiments, a second portion of fronthaul traffic comprises C-Plane and U-Plane traffic. In some embodiments, a second portion of available or active fronthaul ports comprises a second range of available or active fronthaul ports. In some embodiments, a second portion of available or active fronthaul ports comprises half or approximately half of available or active fronthaul ports. In some embodiments, a second portion of available or active fronthaul ports comprises half or approximately half of available or active fronthaul ports that does not include a first portion of available or active fronthaul ports. For example, in some embodiments, a second portion of available or active fronthaul ports maps to all ports with even number identifiers. In another example, in some embodiments, a second portion of available or active fronthaul ports maps to all ports with odd number identifiers. In another example, in some embodiments, a second portion of available or active fronthaul ports to every other port.

Utilizing the O-RAN fronthaul traffic shaping system 600 helps load balance traffic because traffic is more systematically or evenly distributed among available resources. As a result, for example, service impact of dropped packets, is lessened.

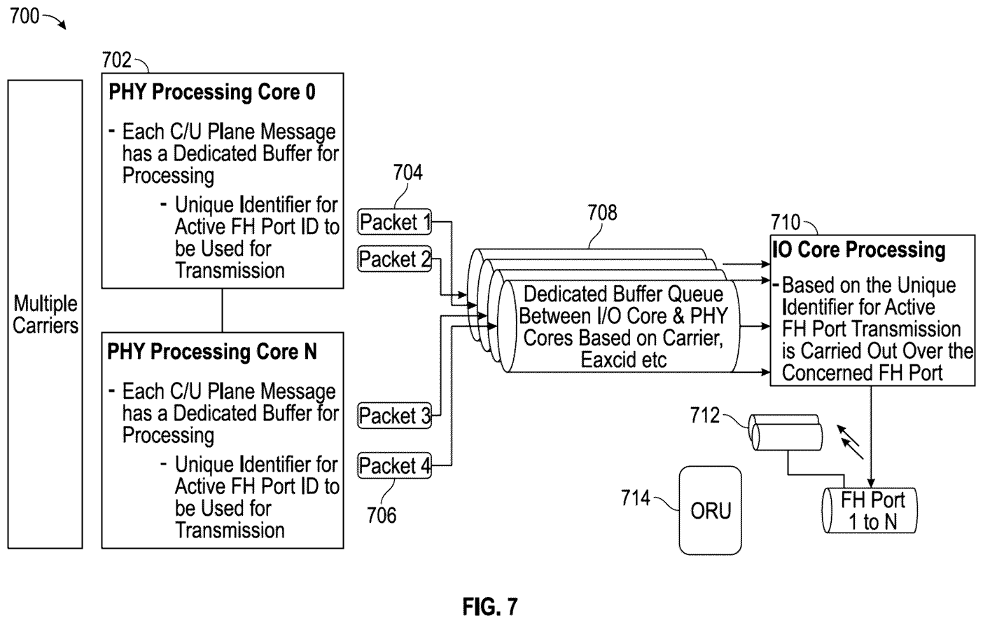

FIG. 7 is a schematic diagram of an O-RAN fronthaul (FH) traffic shaping system 700, in accordance with some embodiments. The O-RAN fronthaul traffic shaping system 700 includes dedicated buffers 708 between I/O Core 710 and PHY Cores 702 (1-N). PHY Cores 1-N are associated with carriers 1-N. Dedicated buffers 708 receive first packets associated with a first carrier 704 and second packets associated with an Nth carrier 706. The O-RAN fronthaul traffic shaping system 700 further includes FH ports 712 (1-N). The O-RAN fronthaul traffic shaping system 700 further includes O-RU 714.

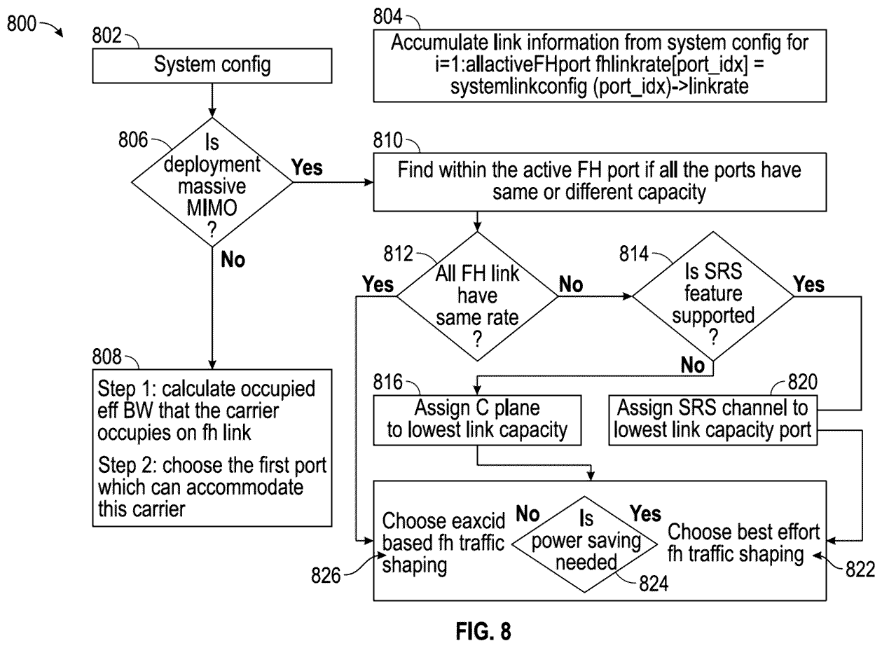

FIG. 8 is a sequence diagram of a method 800 of using an O-RAN fronthaul (FH) traffic shaping system, in accordance with some embodiments.

In operation 802, a system configuration is carried out. In some embodiments, a number of FH ports is selected or preconfigured. In some embodiments, during a system configuration, a determination is made whether one or more fronthaul ports are in an active or in a standby state. In some embodiments, Loopback Messages (LBM) and Loopback Replies (LBR) are used to determine whether a fronthaul port is active. In some embodiments, a heartbeat message is used to determine whether a fronthaul port is active. In some embodiments, if a heartbeat message delivered to a fronthaul port is successful, the fronthaul port is determined to be active or available.

In operation 804, link information is accumulated from the system configuration. In some embodiments, a list of all active FH ports is determined, created, and stored. In some embodiments, a linkrate is determined and stored for each FH port in the list. In some embodiments, a linkrate is ascertained from a system call, API call, or the like. In some embodiments, each linkrate is stored in association with each respective FH port in a data structure. In some embodiments, the data structure is an array. In some embodiments, the data structure is a data structure other than an array.

In operation 806, a determination is made whether a deployment is a Massive Multiple Input Multiple Output (MIMO) deployment. In some embodiments, a determination is made that an associated network deployment or configuration involves a MIMO. In some embodiments, a determination is made that an associated network deployment or configuration does not involve a MIMO. In some embodiments, a determination is made that an associated network deployment or configuration involves a traditional panel. In some embodiments, in response to a determination that an associated network deployment or configuration does not involve a MIMO, operation 808 is executed. In some embodiments, in response to a determination that an associated network deployment or configuration involves a MIMO, operation 810 is executed.

In operation 808, an occupied effective bandwidth (BW) that an associated carrier occupies on an FH link is calculated. In some embodiments, the first port which can accommodate a respective carrier is chosen.

In operation 810, a capacity is determined for each of the ports within a set of active FH ports set. In some embodiments, some ports within a set of active ports have the same capacity or linkrate. In some embodiments, some ports within a set of active ports have a different capacity or linkrate. In some embodiments, all ports within a set of active ports have the same capacity or linkrate. In some embodiments, all ports within a set of active ports have a different capacity or linkrate.

In operation 812, a determination is made whether all the FH ports have the same capacity or linkrate. In some embodiments, if some ports within a set of active ports have a different capacity or linkrate, operation 814 is executed. In some embodiments, if all ports within a set of active ports have the same capacity or linkrate, operation 826 is executed.

In operation 814, a determination is made whether a Sounding Reference Signal (SRS) feature is supported. An SRS is transmitted by a UE on uplink and allows the network to estimate the quality of the channel at different frequencies. In some embodiments, if SRS is not supported, operation 816 is executed. In some embodiments, if SRS is supported, operation 820 is executed.

In operation 816, a traffic shaping method to assign C-Plane traffic to the lowest link capacity port is executed. In some embodiments, the O-RAN fronthaul (FH) traffic shaping system 300 (FIG. 3) is usable to perform the traffic shaping method. In some embodiments, a system other than the O-RAN fronthaul (FH) traffic shaping system 300 (FIG. 3) is usable to perform the traffic shaping method.

In operation 820, an SRS channel is assigned to the lowest linkrate or capacity port. In some embodiments, linkrates or capacities stored in a data structure in association with identifiers of respective FH ports are compared. In some embodiments, an associated identifier for a port is selected based on the comparison.

In operation 822, a best effort traffic shaping method is executed. In some embodiments, the O-RAN fronthaul (FH) traffic shaping system 500 (FIG. 5) is usable to perform the traffic shaping method. In some embodiments, a system other than the O-RAN fronthaul (FH) traffic shaping system 500 (FIG. 5) is usable to perform the traffic shaping method.

In operation 824, a determination is made whether power savings is needed or desirable. In some embodiments, if power savings is needed or desirable, operation 826 is executed. In some embodiments, if power savings is not needed or desirable, operation 822 is executed.

In operation 826, an eAxC-ID based FH traffic shaping method is executed. In some embodiments, the O-RAN fronthaul (FH) traffic shaping system 200 (FIG. 2) is usable to perform the eAxC-ID based FH traffic shaping method. In some embodiments, a system other than the O-RAN fronthaul (FH) traffic shaping system 200 (FIG. 2) is usable to perform the eAxC-ID based FH traffic shaping method.

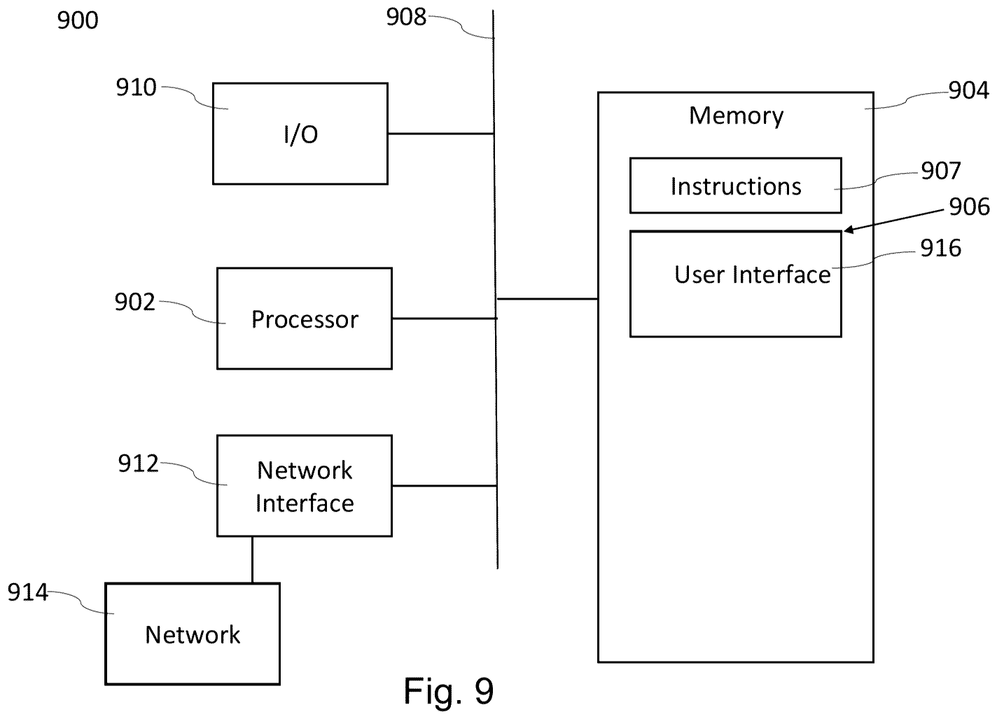

FIG. 9 is a block diagram of computer architecture 900 in accordance with some embodiments.

Computer architecture 900 includes a hardware processor 902 and a non-transitory, computer readable storage medium 904 encoded with, i.e., storing, the computer program code 906, i.e., a set of executable instructions. Computer readable storage medium 904 is also encoded with instructions 907 for interfacing with external devices. The processor 902 is electrically coupled to the computer readable storage medium 904 via a bus 908. The processor 902 is also electrically coupled to an I/O interface 910 by bus 908. A network interface 912 is also electrically connected to the processor 902 via bus 908. Network interface 912 is connected to a network 914, so that processor 902 and computer readable storage medium 904 are capable of connecting to external elements via network 914. The processor 902 is configured to execute the computer program code 906 encoded in the computer readable storage medium 904 in order to cause computer architecture 900 to be usable for performing a portion or all of the operations as described herein.

In some embodiments, the processor 902 is a central processing unit (CPU), a multi-processor, a distributed processing system, an application specific integrated circuit (ASIC), and/or a suitable processing unit.

In some embodiments, the computer readable storage medium 904 is an electronic, magnetic, optical, electromagnetic, infrared, and/or a semiconductor system (or apparatus or device). For example, the computer readable storage medium 904 includes a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium 904 includes a compact disk-read only memory (CD-ROM), a compact disk-read/write (CD-R/W), and/or a digital video disc (DVD).

In some embodiments, the storage medium 904 stores the computer program code 906 configured to cause computer architecture 900 to perform a portion or all of the operations as described herein. In some embodiments, the storage medium 904 also stores information needed for performing a portion or all of the operations as described herein as well as information generated during performing a portion or all of the operations as described herein, such as a user interface parameter 916.

In some embodiments, the storage medium 904 stores instructions 907 for interfacing with external devices. The instructions 907 enable processor 902 to generate instructions readable by the external devices to effectively implement a portion or all of the operations as described herein.

Computer architecture 900 includes I/O interface 910. I/O interface 910 is coupled to external circuitry. In some embodiments, I/O interface 910 includes a keyboard, keypad, mouse, trackball, trackpad, and/or cursor direction keys for communicating information and commands to processor 902.

Computer architecture 900 also includes network interface 912 coupled to the processor 902. Network interface 912 allows computer architecture 900 to communicate with network 914, to which one or more other computer systems are connected. Network interface 912 includes wireless network interfaces such as BLUETOOTH, WIFI, WIMAX, GPRS, or WCDMA; or wired network interface such as ETHERNET, USB, or IEEE-1394. In some embodiments, a portion or all of the operations as described herein, and information are exchanged between different computer architecture 900 via network 914.

In at least some embodiments, the apparatus is another device capable of processing logical functions in order to perform the operations herein. In at least some embodiments, the controller and the storage unit need not be entirely separate devices, but share circuitry or one or more computer-readable mediums in some embodiments. In at least some embodiments, the storage unit includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of a controller responsible for performing operations. In at least some embodiments, certain steps and sections are implemented by dedicated circuitry, programmable circuitry supplied with computer-readable instructions stored on computer-readable media, or processors supplied with computer-readable instructions stored on computer-readable media. In at least some embodiments, dedicated circuitry includes digital and/or analog hardware circuits and include integrated circuits (IC) and/or discrete circuits. In at least some embodiments, programmable circuitry includes reconfigurable hardware circuits including logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In at least some embodiments, computer readable program instructions described herein are downloadable to respective computing/processing devices from a computer readable storage medium or to an external computer or external storage device via a network, for example, the Internet, a local area network, a wide area network and/or a wireless network. In at least some embodiments, the network includes copper transmission cables, optical transmission fibers, wireless transmission, routers, firewalls, switches, gateway computers and/or edge servers. In at least some embodiments, a network adapter card or network interface in each computing/processing device receives computer readable program instructions from the network and forwards the computer readable program instructions for storage in a computer readable storage medium within the respective computing/processing device.

In at least some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In at least some embodiments, the computer readable program instructions are executed entirely on the user's computer, partly on the user's computer, as a stand-alone software package, partly on the user's computer and partly on a remote computer or entirely on the remote computer or server. In at least some embodiments, in the latter scenario, the remote computer is connected to the user's computer through any type of network, including a local area network (LAN) or a wide area network (WAN), or the connection is made to an external computer (for example, through the Internet using an Internet Service Provider). In at least some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the subject disclosure.

While embodiments of the subject disclosure have been described, the technical scope of any subject matter claimed is not limited to the above-described embodiments. Persons skilled in the art would understand that various alterations and improvements to the above-described embodiments are possible. Persons skilled in the art would also understand from the scope of the claims that the embodiments added with such alterations or improvements are included in the technical scope of the disclosure.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

### Supplemental Note 1

A system includes a non-transitory computer readable medium configured to store instructions thereon. The system further includes a processor connected to the non-transitory computer readable medium. The processor is configured to execute the instructions for identifying a first set of fronthaul ports comprising a first fronthaul port. The processor is configured to execute the instructions for identifying a second set of fronthaul ports comprising a second fronthaul port. The processor is configured to execute the instructions for determining whether the first fronthaul port is active. The processor is configured to execute the instructions for determining whether the second fronthaul port is active. The processor is configured to execute the instructions for assigning a first portion of fronthaul traffic to the first set of fronthaul ports based on a first set of determinations, wherein the first set of determinations comprise a first port activity determination that the first fronthaul port is active. The processor is configured to execute the instructions for assigning a second portion of the fronthaul traffic to the second set of fronthaul ports based on a second set of determinations.

### Supplemental Note 2

In some embodiments, the processor of Supplemental Note 1 wherein the first set of determinations further comprises:
a first eAxCid determination that an eAxCid of the first fronthaul port is within a first range; and
wherein the second set of determinations further comprises:
a second eAxCid determination that an eAxCid of the second fronthaul port is within a second range.

### Supplemental Note 3

In some embodiments, the processor of any of Supplemental Notes 1-2 wherein the first set of determinations further comprises:
a first traffic determination that the first portion of fronthaul traffic is control plane traffic; and
wherein the second set of determinations further comprises:
a second traffic determination that the second portion of fronthaul traffic is user plane traffic.

### Supplemental Note 4

In some embodiments, the processor of any of Supplemental Notes 1-3 wherein the first set of determinations further comprises:
a first traffic determination that the first portion of fronthaul traffic is associated with a first carrier; and
wherein the second set of determinations further comprises:
a second traffic determination that the second portion of fronthaul traffic is associated with a second carrier.

### Supplemental Note 5

In some embodiments, the processor of any of Supplemental Notes 1-4 wherein the second set of determinations further comprises:
a load determination that the first fronthaul port is exhausted.

### Supplemental Note 6

In some embodiments, the processor of any of Supplemental Notes 1-5 wherein the first set of determinations further comprises:
a first traffic determination that the first portion of fronthaul traffic is downlink traffic; and
wherein the second set of determinations further comprises:
a second traffic determination that the second portion of fronthaul traffic is uplink traffic.

### Supplemental Note 7

In some embodiments, the processor of any of Supplemental Notes 1-6 wherein the first set of fronthaul ports and the second set of fronthaul ports comprise an equal number of member ports.

### Supplemental Note 8

A method includes identifying a first set of fronthaul ports comprising a first fronthaul port. The method further includes identifying a second set of fronthaul ports comprising a second fronthaul port. The method further includes determining whether the first fronthaul port is active. The method further includes determining whether the second fronthaul port is active. The method further includes assigning a first portion of fronthaul traffic to the first set of fronthaul ports based on a first set of determinations, wherein the first set of determinations comprise a first port activity determination that the first fronthaul port is active. The method further includes assigning a second portion of the fronthaul traffic to the second set of fronthaul ports based on a second set of determinations.

### Supplemental Note 9

The method of Supplemental Note 8 wherein the first set of determinations further comprises:
a first eAxCid determination that an eAxCid of the first fronthaul port is within a first range; and
wherein the second set of determinations further comprises:
a second eAxCid determination that an eAxCid of the second fronthaul port is within a second range.

### Supplemental Note 10

The method of any of Supplemental Notes 8-9 wherein the first set of determinations further comprises:
a first traffic determination that the first portion of fronthaul traffic is control plane traffic; and
wherein the second set of determinations further comprises:
a second traffic determination that the second portion of fronthaul traffic is user plane traffic.

### Supplemental Note 11

The method of any of Supplemental Notes 8-10 wherein the first set of determinations further comprises:
a first traffic determination that the first portion of fronthaul traffic is associated with a first carrier; and
wherein the second set of determinations further comprises:
a second traffic determination that the second portion of fronthaul traffic is associated with a second carrier.

### Supplemental Note 12

The method of any of Supplemental Notes 8-11 wherein the second set of determinations further comprises:
a load determination that the first fronthaul port is exhausted.

### Supplemental Note 13

The method of any of Supplemental Notes 8-12 wherein the first set of determinations further comprises:
a first traffic determination that the first portion of fronthaul traffic is downlink traffic; and
wherein the second set of determinations further comprises:
a second traffic determination that the second portion of fronthaul traffic is uplink traffic.

### Supplemental Note 14

The method of any of Supplemental Notes 8-13 wherein the first set of fronthaul ports and the second set of fronthaul ports comprise an equal number of member ports.

### Supplemental Note 15

A non-transitory computer readable medium configured to store instructions thereon. The instructions are configured to cause a processor to perform operations comprising identifying a first set of fronthaul ports comprising a first fronthaul port. The instructions are configured to cause a processor to perform operations comprising identifying a second set of fronthaul ports comprising a second fronthaul port. The instructions are configured to cause a processor to perform operations comprising determining whether the first fronthaul port is active. The instructions are configured to cause a processor to perform operations comprising determining whether the second fronthaul port is active. The instructions are configured to cause a processor to perform operations comprising assigning a first portion of fronthaul traffic to the first set of fronthaul ports based on a first set of determinations, wherein the first set of determinations comprise a first port activity determination that the first fronthaul port is active. The instructions are configured to cause a processor to perform operations comprising assigning a second portion of the fronthaul traffic to the second set of fronthaul ports based on a second set of determinations.

### Supplemental Note 16

The non-transitory computer readable medium of Supplemental Note 15, wherein the first set of determinations further comprises:
a first eAxCid determination that an eAxCid of the first fronthaul port is within a first range; and
wherein the second set of determinations further comprises:
a second eAxCid determination that an eAxCid of the second fronthaul port is within a second range.

### Supplemental Note 17

The non-transitory computer readable medium of any of Supplemental Notes 15-16, wherein the first set of determinations further comprises:
a first traffic determination that the first portion of fronthaul traffic is control plane traffic; and
wherein the second set of determinations further comprises:
a second traffic determination that the second portion of fronthaul traffic is user plane traffic.

### Supplemental Note 18

The non-transitory computer readable medium of any of Supplemental Notes 15-17, wherein the first set of determinations further comprises:
a first traffic determination that the first portion of fronthaul traffic is associated with a first carrier; and
wherein the second set of determinations further comprises:
a second traffic determination that the second portion of fronthaul traffic is associated with a second carrier.

### Supplemental Note 19

The non-transitory computer readable medium of any of Supplemental Notes 15-18, wherein the second set of determinations further comprises:
a load determination that the first fronthaul port is exhausted.

### Supplemental Note 20

The non-transitory computer readable medium of any of Supplemental Notes 15-19, wherein the first set of determinations further comprises:
a first traffic determination that the first portion of fronthaul traffic is downlink traffic; and
wherein the second set of determinations further comprises:
a second traffic determination that the second portion of fronthaul traffic is uplink traffic.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system comprising:
a non-transitory computer readable medium configured to store instructions thereon; and
a processor connected to the non-transitory computer readable medium, wherein the processor is configured to execute the instructions for:
identifying a first set of fronthaul ports comprising a first fronthaul port;
identifying a second set of fronthaul ports comprising a second fronthaul port;
determining whether the first fronthaul port is active;
determining whether the second fronthaul port is active;
assigning a first portion of fronthaul traffic to the first set of fronthaul ports based on a first set of determinations, wherein the first set of determinations comprise:
a first port activity determination that the first fronthaul port is active;
assigning a second portion of the fronthaul traffic to the second set of fronthaul ports based on a second set of determinations.

2. The system of claim 1, wherein the first set of determinations further comprises:
a first eAxCid determination that an eAxCid of the first fronthaul port is within a first range; and
wherein the second set of determinations further comprises:
a second eAxCid determination that an eAxCid of the second fronthaul port is within a second range.

3. The system of claim 1, wherein the first set of determinations further comprises:
a first traffic determination that the first portion of fronthaul traffic is control plane traffic; and
wherein the second set of determinations further comprises:
a second traffic determination that the second portion of fronthaul traffic is user plane traffic.

4. The system of claim 1, wherein the first set of determinations further comprises:
a first traffic determination that the first portion of fronthaul traffic is associated with a first carrier; and
wherein the second set of determinations further comprises:
a second traffic determination that the second portion of fronthaul traffic is associated with a second carrier.

5. The system of claim 1, wherein the second set of determinations further comprises:
a load determination that the first fronthaul port is exhausted.

6. The system of claim 1, wherein the first set of determinations further comprises:
a first traffic determination that the first portion of fronthaul traffic is downlink traffic; and
wherein the second set of determinations further comprises:
a second traffic determination that the second portion of fronthaul traffic is uplink traffic.

7. The system of claim 2, wherein the first set of fronthaul ports and the second set of fronthaul ports comprise an equal number of member ports.

8. A method, the method comprising:
identifying a first set of fronthaul ports comprising a first fronthaul port;
identifying a second set of fronthaul ports comprising a second fronthaul port;
determining whether the first fronthaul port is active;
determining whether the second fronthaul port is active;
assigning a first portion of fronthaul traffic to the first set of fronthaul ports based on a first set of determinations, wherein the first set of determinations comprise:
a first port activity determination that the first fronthaul port is active;
assigning a second portion of the fronthaul traffic to the second set of fronthaul ports based on a second set of determinations.

9. The method of claim 8, wherein
a first eAxCid determination that an eAxCid of the first fronthaul port is within a first range; and
wherein the second set of determinations further comprises:
a second eAxCid determination that an eAxCid of the second fronthaul port is within a second range.

10. The method of claim 8, further comprising:
a first traffic determination that the first portion of fronthaul traffic is control plane traffic; and
wherein the second set of determinations further comprises:
a second traffic determination that the second portion of fronthaul traffic is user plane traffic.

11. The method of claim 8, further comprising:
a first traffic determination that the first portion of fronthaul traffic is associated with a first carrier; and
wherein the second set of determinations further comprises:
a second traffic determination that the second portion of fronthaul traffic is associated with a second carrier.

12. The method of claim 8, wherein the second set of determinations further comprises:
a load determination that the first fronthaul port is exhausted.

13. The method of claim 8, wherein the first set of determinations further comprises:
a first traffic determination that the first portion of fronthaul traffic is downlink traffic; and
wherein the second set of determinations further comprises:
a second traffic determination that the second portion of fronthaul traffic is uplink traffic.

14. The method of claim 9, wherein the first set of fronthaul ports and the second set of fronthaul ports comprise an equal number of member ports.

15. A non-transitory computer readable medium configured to store instructions thereon, wherein the instructions are configured to cause a processor to perform operations comprising:
identifying a first set of fronthaul ports comprising a first fronthaul port;
identifying a second set of fronthaul ports comprising a second fronthaul port;
determining whether the first fronthaul port is active;
determining whether the second fronthaul port is active;
assigning a first portion of fronthaul traffic to the first set of fronthaul ports based on a first set of determinations, wherein the first set of determinations comprise:
a first port activity determination that the first fronthaul port is active;
assigning a second portion of the fronthaul traffic to the second set of fronthaul ports based on a second set of determinations.

16. The non-transitory computer readable medium of claim 15, wherein the first set of determinations further comprises:
a first eAxCid determination that an eAxCid of the first fronthaul port is within a first range; and
wherein the second set of determinations further comprises:
a second eAxCid determination that an eAxCid of the second fronthaul port is within a second range.

17. The non-transitory computer readable medium of claim 15, wherein the first set of determinations further comprises:
a first traffic determination that the first portion of fronthaul traffic is control plane traffic; and
wherein the second set of determinations further comprises:
a second traffic determination that the second portion of fronthaul traffic is user plane traffic.

18. The non-transitory computer readable medium of claim 15, wherein the first set of determinations further comprises:
a first traffic determination that the first portion of fronthaul traffic is associated with a first carrier; and
wherein the second set of determinations further comprises:
a second traffic determination that the second portion of fronthaul traffic is associated with a second carrier.

19. The non-transitory computer readable medium of claim 15, wherein the second set of determinations further comprises:
a load determination that the first fronthaul port is exhausted.

20. The non-transitory computer readable medium of claim 15, wherein the first set of determinations further comprises:
a first traffic determination that the first portion of fronthaul traffic is downlink traffic; and
wherein the second set of determinations further comprises:
a second traffic determination that the second portion of fronthaul traffic is uplink traffic.
